(19) United States
(12) Patent Application Publication
(10) Pub. No.: US 2011/0067510 A1
(43) Pub. Date: Mar. 24, 2011

(54) ECCENTRIC VIBRATING AMPLITUDE DEVICE OF A VIBRATOR

(76) Inventor: Huan Yao PENG, (US)

(21) Appl. No.: 12/958,042

(22) Filed: Dec. 1, 2010

(30) Foreign Application Priority Data
Feb. 12, 2009 (TW) 098222567

(51) Int. Cl. F16H 33/10

(52) U.S. Cl. 74/87

(57) ABSTRACT

An eccentric vibrating amplitude device of a vibrator includes an eccentric unit on at least one end of an extended shaft of a reversible motor and includes a balance block located at an innermost location of the eccentric unit mounted on a shaft and an eccentric block located at the outermost location. on the shaft. The balance block and eccentric block include an eccentric round hole block and eccentric blocks for receiving the shaft. When mounted on the extended shaft of a reversible motor, the rotational angle between the balance block and the eccentric block and the torque on the motor selectively changes when the motor rotates in a positive or a negative direction. Hence there is provided a selectable or variable vibrating amplitude intensity.

### CROSS-REFERENCE TO RELATED APPLICATIONS

The present application claims priority under 35 U.S.C.. 119 of Taiwanese Application No. 098222567 filed Dec. 2, 2009, the disclosure of which is expressly incorporated by reference herein in its entirety.

### FIELD OF THE INVENTION

The present invention relates to a vibrating amplitude vibrator device. In particular, the present invention relates to an eccentric unit mounted on extended shafts at both ends of a motor which rotate at least one balance block and eccentric blocks in a positive or negative direction so as to generate various torque results due to interaction of the variable angles between them.

### BACKGROUND OF THE INVENTION

Conventional vibrators controlled by PCB of a DC motor come with a single amplitude which generates a single torque as a vibrator. It is impossible to provide different torques in various intensities to a customer's demand with a flexible selection of satisfactory functions. Besides, in order to provide a customer's requirement of different intensities of amplitude by replacing an eccentric board loaded on both ends of motor is extremely inconvenient to the customer.

### SUMMARY OF THE INVENTION

The preferred embodiment the present invention pertains to a motor that can rotate in a positive or a negative direction to drive eccentric blocks and at least one balance block. This rotation interchangeably changes the angles and results in different torques. Thus the present invention provides a selectable, variable vibrating amplitude in the intensity of the vibrator.

### BRIEF DESCRIPTION OF THE DRAWINGS

FIG. 1 is a partially exploded perspective view that depicts that part of the structure of an eccentric vibrating amplitude vibrator device of a vibrator of a first example that is a first embodiment of the invention.

FIG. 2 is a front perspective view of the device depicted in FIG. 1 in an assembled condition.

FIG. 3 is a partially exploded perspective view that depicts that part of the structure of an eccentric vibrating amplitude vibrator device of a vibrator of a second example that is a second embodiment of the present invention.

FIG. 4 is a front perspective view of the device depicted in FIG. 3 shown in an assembled condition.

FIG. 5 is a partially exploded perspective view that depicts that part of the structure of an eccentric vibrating amplitude vibrator device of a vibrator of a third example that is a third embodiment of the present invention.

FIG. 6 is a front perspective view of the device shown in FIG. 5 in an assembled condition.

FIG. 7 is a partially exploded perspective view that depicts that part of the structure of an eccentric vibrating amplitude vibrator device of a vibrator of a fourth example that is a fourth embodiment of the present invention.

FIG. 8 is a front perspective view of the device shown in FIG. 7 in an assembled condition.

FIG. 9 is a partially exploded perspective view that depicts that part of the structure of an eccentric vibrating amplitude vibrator device of a vibrator of a fifth example that is a fifth embodiment of the present invention.

FIG. 10 is a front perspective view of the device shown in FIG. 9 in an assembled condition.

### DESCRIPTION OF THE PREFERRED EMBODIMENT

As a result of research, the inventor developed a device for generating an eccentric vibrating amplitude for a vibrator that is primarily comprised of an eccentric unit on one or both ends of an extended motor shaft. The eccentric unit includes a balance block mounted at the most inner location on the shaft and an eccentric block mounted at the most outer location of the shaft. The eccentric block is mounted on the shaft by a washer and a screw; and the shaft penetrates through eccentrically located round holes on balance block and eccentric block.

A purpose of the invention is to generate various torques and produce the vibration effects therefrom. Another purpose is to provide a selection of vibrating amplitudes of the vibrator having different intensities from a switching motor by changing the angles between at least one balance block and a plurality of eccentric blocks, the motor being capable of being switched in a positive or a negative direction, that is, in a clockwise and counter clockwise direction.

The present invention provides a customer flexible choice in the vibrating amplitude when in use, for example in the application of fitness equipment or other machines, so as to satisfy a customer's demand.

### Specific Examples Or Embodiments

In order to reveal the complete technological skill of the invention, reference is made to the attached drawings, depicting the preferred embodiments of the present invention as follows.

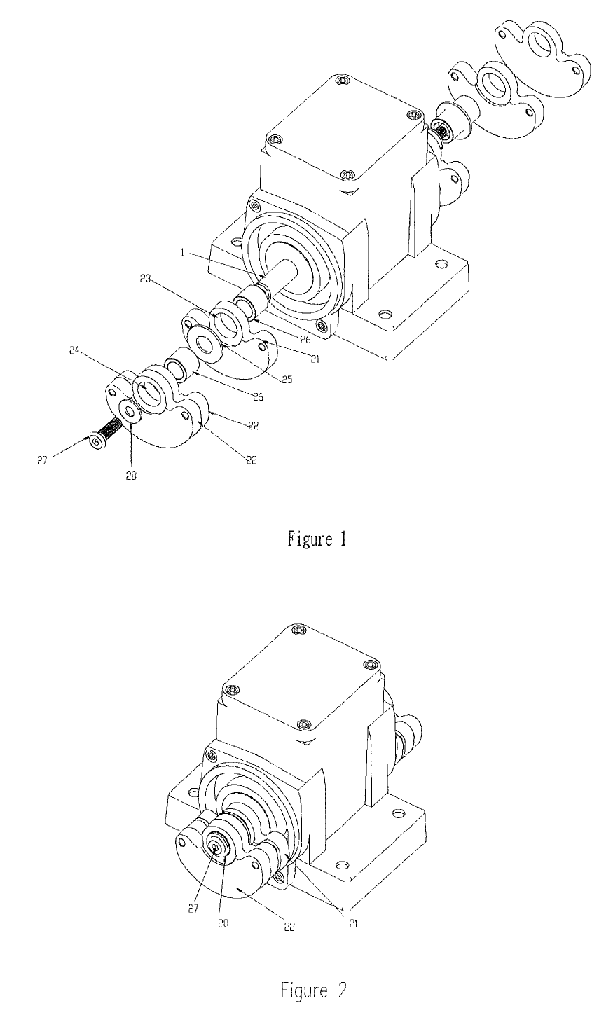

First, reference is made to the embodiment of the invention depicted in FIGS. 1 & 2, which is a first example. The invention is a device to generate eccentric vibrating amplitude of vibrator, which is primarily comprised of an eccentric unit on an extended shaft 1 of a motor at both ends (only one of which is depicted in FIG. 1, the other end being substantially the same. A balance block 21 is mounted on shaft 1. A reverse, single-direction bearing 26 is mounted on shaft 1 between it and balance block 21.

A plurality of eccentric blocks 22 (two in the embodiment of FIG. 1) that are substantially the same are mounted at an outward or external location on of shaft 1. Eccentric blocks 22 are mounted on shaft 1 with a washer 28 and a screw 27. In this embodiment of FIG. 1, the several eccentric blocks are connected together, such as by being welded to one another.

A positive single-direction bearing 26 is located on shaft 1 in between several eccentric blocks 22 and balance block 21. Behind bearing 26 and in front of balance block 21, mounted on shaft 1 is a washers 25.

Balance block 21 and several eccentric blocks 22 have a special fan-shape and each has a bearing hole 23 and 24, respectively. When motor shaft 1 rotates in clockwise, it drives eccentric block 22 with balance block 21 unmoved to generate larger torque. When motor shaft 1 rotates in counter clockwise, it drives balance block 21 with eccentric block 22 unmoved to generate smaller torque.

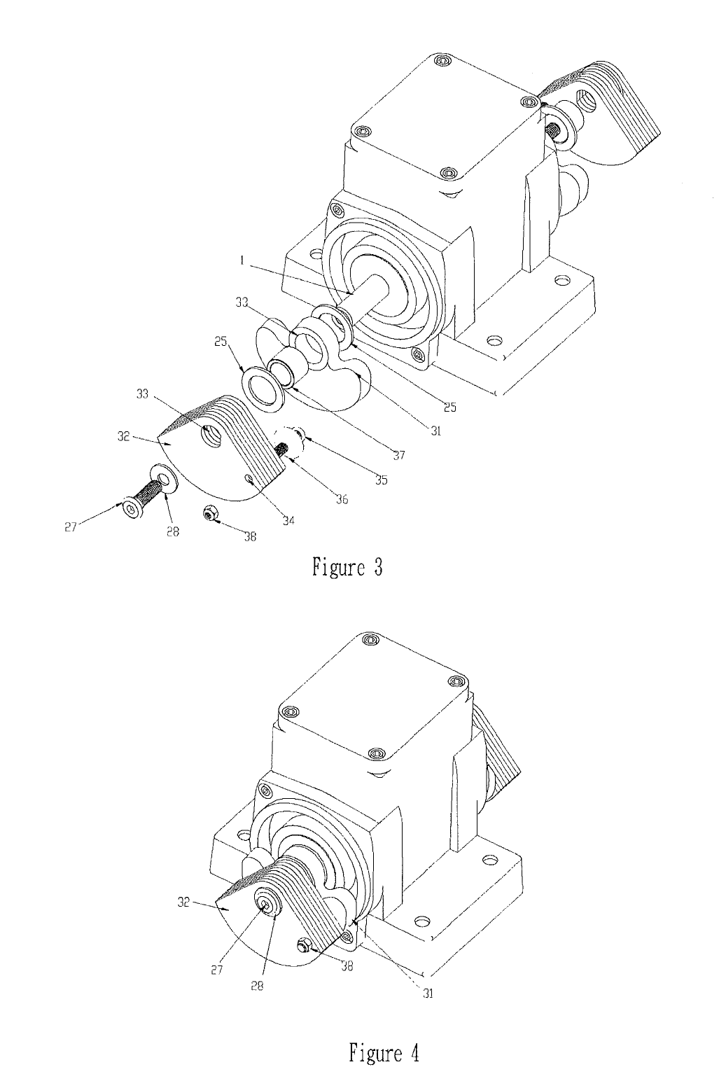

Please refer to FIGS. 3 and 4, concerning a second embodiment of the invention of eccentric vibrating amplitude of vibrator on the eccentric unit on the extended shaft 1 of the motor at both ends (only one end of which is shown, but the other end is substantially the same.

There are washers 25 and balance block 31 mounted on shaft 1 at the most inner location of the eccentric unit. Balance block 31 has a fan-shape with a round hole 33 that receives a socket 37, also mounted on shaft 1, in it at the center 1.

Several eccentric blocks 32 are placed and mounted at the outer external location of shaft 1 by washer 28 and bolt 27. Eccentric blocks are connected together, such as by being welded to one another.

There are washers 25 mounted on shaft 1 and located between balance block 31 and eccentric blocks 32. Eccentric blocks 32 have a fan-shape with one round hold 33 at the center which receives shaft 1. A screw 35 and a nut 38 are mounted in a side screw hole 34 of eccentric blocks 32. The head of screw 35 is coated with a rubbery compound, including rubber, and a rubber ring 36 is mounted on screw 35.

When the motor rotates in a clockwise or a counter clockwise rotation, motor shaft 1 drives balance block 31 and several eccentric block 32, which changes the angle between them so as to vary the loading weight and generate a different torque effect.

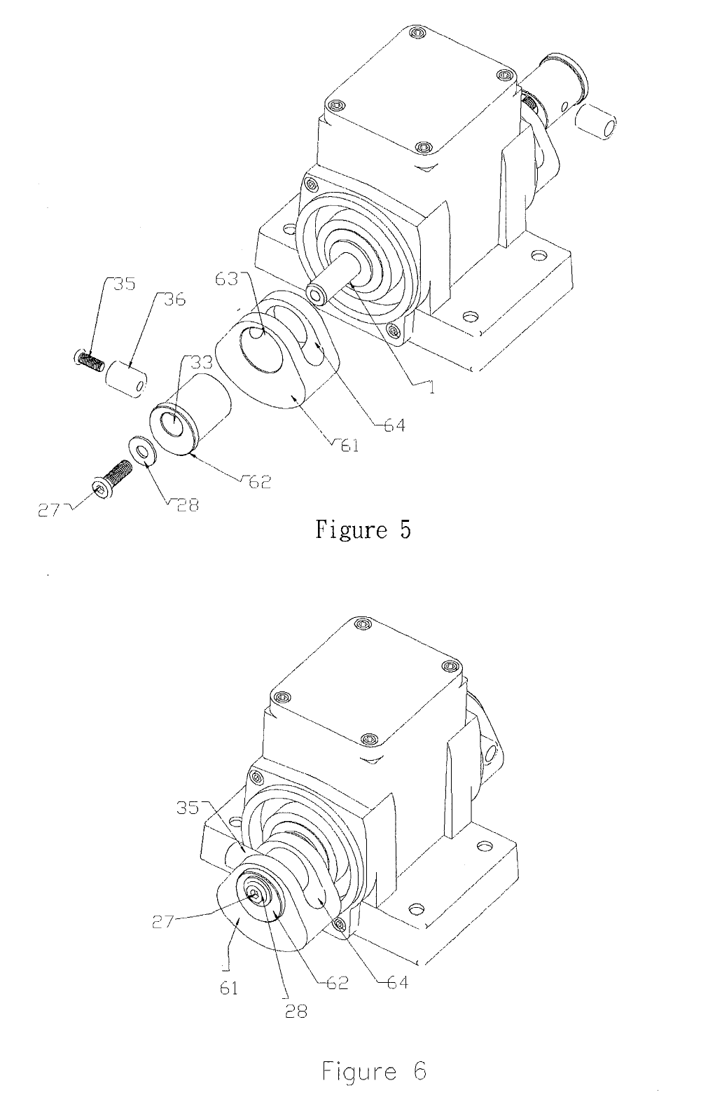

Please refer to FIGS. 5 and 6, concerning a third example and embodiment of the invention of eccentric vibrating amplitude of vibrator on the eccentric unit on the extended shaft 1 of the motor at both ends (only one end of which is shown, but the other end is substantially the same).

The eccentric unit also includes a balance 61 mounted on shaft 1 at the most inner location. Balance 61 has a fan-shape with a large round hole 63 at the center and also has an arc groove 64.

An eccentric block 62 is located at the outer most location on shaft 1 and is mounted thereon by washer 28 and screw bolt 27. Eccentric block 62 has an annular cylindrical-shape with a single round hole 33. A screw 35 extends radially outwardly from a screw hole in the side of eccentric block 62. The head of screw 35 is coated with a rubber-like material, which could include rubber, and has a rubber ring 36 mounted on screw 35. Eccentric block 62 is inserted into large round hold 63 in balance block 61. Screw 35 is fastened through arc groove 64 of balance block 61 into the screw hole of eccentric block 62.

When the motor rotates in a clockwise or a counter clockwise direction, motor shaft 1 drives balance block 61 and eccentric block 62 from the same side or a different side, respectively, to vary interchangeably both the weight and a different torque effect that is generated.

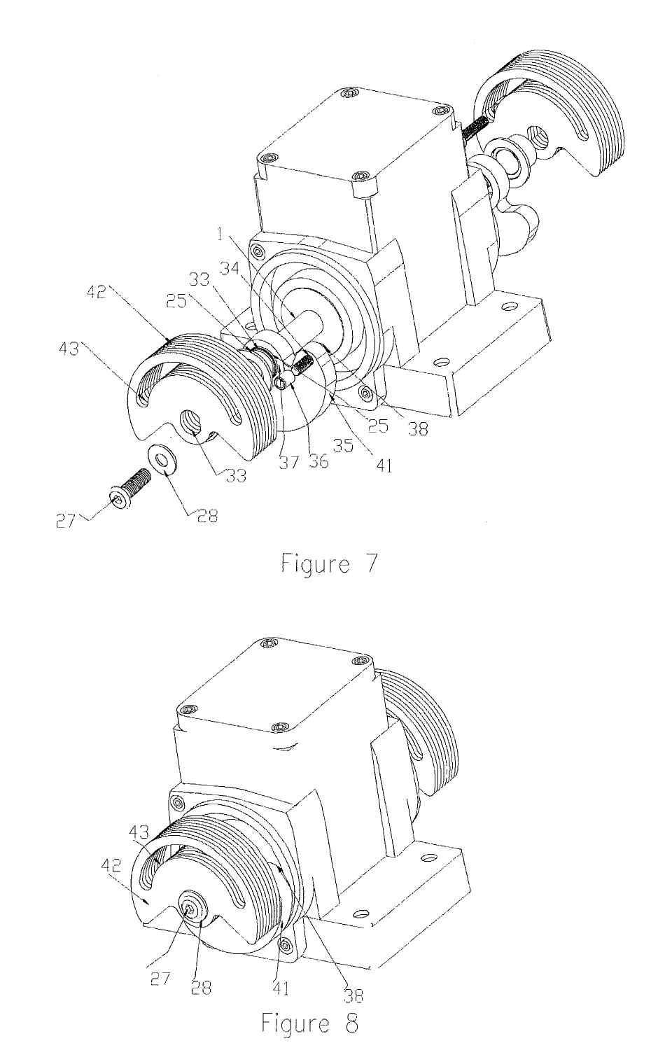

Please refer to FIGS. 7 and 8, concerning a fourth example and embodiment of the invention of eccentric vibrating amplitude of vibrator on the eccentric unit on the extended shaft 1 of the motor at both ends (only one end of which is shown, but the other end is substantially the same).

The eccentric unit includes a washer 25 and a balance block 41 mounted on shaft 1 at the inner most location on shaft 1. Balance block 41 has a fan-shape with a round hole 33 along the inner edge of balance block 41 through which shaft 1 extends. Round hole 33 receives a socket 37. Balance block 41 also has a screw hole 34 located on an upper arm thereof which receives a screw 35. A nut 38 secures screw 35 in screw hole 34 for mounting screw 35. The head of screw 35 has a rubber-like coating, which can include rubber, and screw 35 has an outer annular ring 36 mounted on the shaft thereof.

Several eccentric blocks 42 are located and mounted at the outer most location on shaft 1. Blocks 42 are connected together, such as by being welded to one another. Eccentric blocks 42 have a fan shape and a round hole 33 at a lower portion thereof for receiving shaft 1. Eccentric blocks 42 also have an arcuate slot or groove 43 therethrough at the edge portion thereof that is opposite hole 33. Also, a washer 25 is located between the outer most side of balance block 41 and the inner most side of eccentric block 42.

When the motor rotates in a clockwise or a counter clockwise direction, motor shaft 1 drives or rotates balance block 41 and the several eccentric blocks 42. The screw head of screw 35 in balance block 41 extends through the arcuate slot or groove 43 of eccentric block 42. Thus the rotational angle between balance block 41 and eccentric blocks 42 is changed, resulting in a variable change of both the weight and the torque effect, thereby generating different torques.

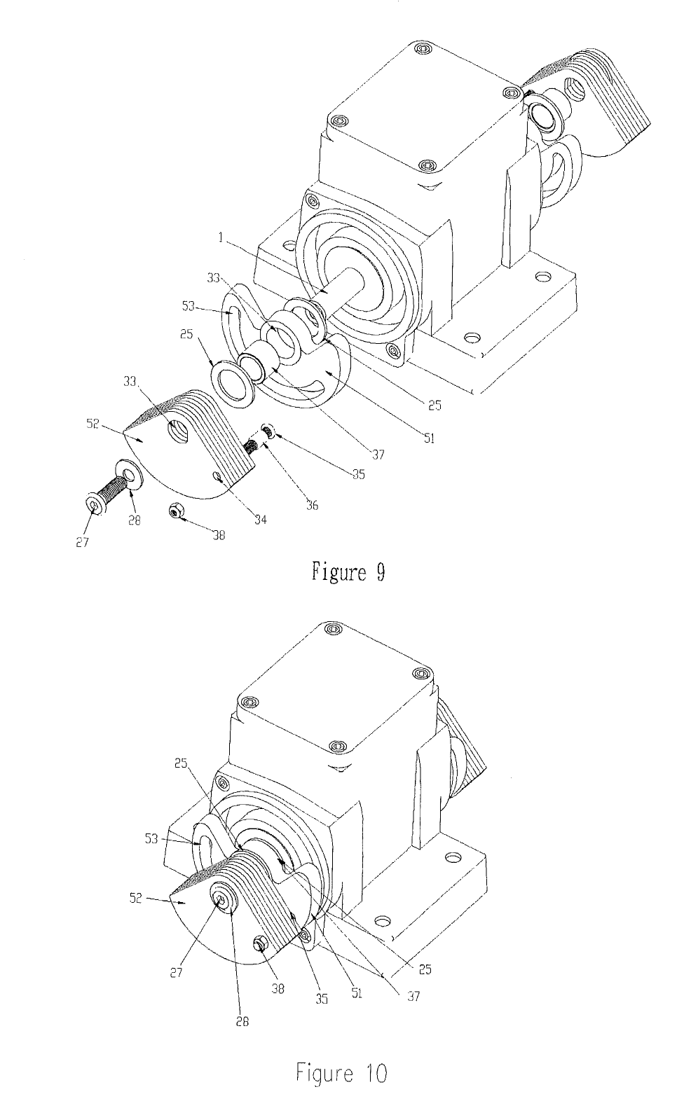

Please refer to FIGS. 9 and 10, concerning a fifth example and embodiment of the invention of eccentric vibrating amplitude of vibrator on the eccentric unit on the extended shaft 1 of the motor at both ends (only one end of which is shown, but the other end is substantially the same).

The eccentric unit includes a washer 25 and a balance block 51 mounted on shaft 1 at the inner most location on shaft 1. Balance block 51 has a fan-shape with a round hole 33 along the inner edge of balance block 41 through which shaft 1 extends. Round hole 33 receives a socket 37. The side of balance block 51 has an arcuate slot or groove 53 located along the lower edge portion of balance block 5 and generally aligned with the bottom arcuate edge of balance block 51.

Several eccentric blocks 52 are located and mounted at the outer most location on shaft 1 by washer 28 and screw bolt 27 that is received in a threaded bore (not shown) in the end of shaft 1. Blocks 52 are connected together, such as by being welded to one another. Eccentric blocks 42 have a fan shape or a circle segment shape and have a screw hole 34 at a lower portion thereof for receiving a bolt 35 and a mounting nut 38. The head of screw 35 has a rubber-like coating, which can be of rubber. Screw 35 also has an encircling rubber ring 36. Also, a washer 25 is located between the outer most side of balance block 51 and the inner most side of eccentric block 52.

When the motor rotates in a clockwise or a counter clockwise direction, motor shaft 1 drives or rotates balance block 51 and the several eccentric blocks 52. The screw head of screw 35 in balance block 41 then extends through the arcuate slot or groove 43 of eccentric block 42. Thus the rotational angle between balance block 41 and eccentric blocks 42 is changed, resulting in a variable change of both the weight and the torque effect, thereby generating different torques.

Therefore, the motor of the eccentric vibrating amplitude of vibrator is a positive/negative rotating motor which changes the angles between balance block 51 and eccentric blocks 52 by rotating in positive or negative direction and generating different torques, and hence provides the function of selecting the intensity the vibrating amplitude of the vibrator.

While this invention has been particularly shown and described with reference to preferred embodiments thereof, it will be understood by those skilled in the art that various changes in form and details may be made therein without departing from the spirit and scope of the invention as defined by the appended claims.

I claim:

1. An eccentric vibrating amplitude device in which the vibrator is comprised of an eccentric unit mounted on an extended portion of a shaft of a motor at, at least one end of the shaft, the eccentric unit comprising:
a balance block having a bearing hole therein for receiving the extended portion of the shaft;
a reversed single-direction bearing mounted on the shaft between the inner side defining the hole of said balance block and the shaft;
an eccentric block having a bearing hole therein for the extended portion of the shaft and mounted on the shaft at the outer most outer location of the shaft;
a positive single-direction bearing mounted on the shaft between the inner side defining the hole of said eccentric block and the shaft;
a washer located between the inner most location of said balance block and said eccentric block; and wherein
said balance block and said eccentric block have a fan-shape, and said bearing hole of said balance block being located at the center thereof and said bearing hole of said eccentric block being located at the center thereof.

2. An eccentric vibrating amplitude device in which the vibrator is comprised of an eccentric unit mounted on an extended portion of a shaft of a motor at, at least one end of the shaft, the eccentric unit comprising:
a balance block that has a fan-shape appearance in elevational view and a round hole at an upper portion thereof for receiving the shaft;
a socket mounted in said balance block round hole;
an eccentric block mounted at an outer location on the shaft, said eccentric block having a fan shape in elevational view, said eccentric block having a round hole at an upper portion thereof;
a washer mounted on said shaft in between said balance block and said eccentric block, which are in fan-shape with a round hold at the center near the shaft.

3. An eccentric vibrating amplitude device as claimed in claim 2, wherein the depicted eccentric vibrating amplitude device of vibrator, several eccentric blocks come with screw holes at side for fastening by screws and nuts; where the head of screws is coated by rubber with a rubber ring in the screws is its feature.

4. An eccentric vibrating amplitude device, of which comes with an eccentric unit on the extended shaft of motor at both ends, which comprises:
a balance block is equipped at the most inner layer of eccentric unit, which is in special fan-shape with a big round hold at the center;
the surface of the fan-shape comes with an arc groove; where the eccentric blocks are equipped and mounted at the most outer layer of shaft by washers and screw bolts;
the eccentric blocks are in round shape with a round hole; where the side of eccentric block comes with screw holes for fastening by screws, and the head of screws is coated with rubber with rubber ring in it.

5. An eccentric vibrating amplitude device as claimed in claim 4, wherein an eccentric vibrating amplitude device of vibrator, the eccentric blocks are set in the big round hole of the balance block with screw fastening from the arc groove of balance block into the screw holes of eccentric block is its feature.

6. An eccentric vibrating amplitude device, of which having an eccentric unit on the extended shaft of motor at both ends, which comprises:
the most inner layer of eccentric unit comes with washers and balance block; where balance block is in special fan-shape with a round hole at the center near the shaft; where a socket is set in the round hole; where several eccentric blocks are set and mounted at the most outer layer of shaft by washers an screws;
the several eccentric blocks are welded together; where they are in special fan-shape with a round hole at the center near the shaft; also a washer is set between the most inner layer of balance block and several eccentric block.

7. An eccentric vibrating amplitude device as claimed in claim 6, wherein an eccentric vibrating amplitude device of vibrator, the side of balance block comes with a screw hole for fastening by screws and nuts; where the head of screws is coated with rubber with a rubber ring in the screws.

8. An eccentric vibrating amplitude device as claimed in claim 6, wherein an eccentric vibrating amplitude device of vibrator comes with several eccentric blocks in fan-shape with an arc groove is its feature.

9. An eccentric vibrating amplitude device as claimed in claim 6, wherein an eccentric vibrating amplitude device of vibrator comes with motor in driving balance block and several eccentric blocks; where the screw head of balance block stretches into the arc grooves of eccentric blocks, which to change the angle between balance block and several eccentric blocks is its feature.

10. An eccentric vibrating amplitude device, of which primarily comes with an eccentric unit on the extended shaft of motor at both ends, which comprises:
The most inner layer of the eccentric unit comes with washer and balance block; where the balance block is in special fan-shape with a round hole at the center near the shaft; where a socket is set in the round hold; where several eccentric blocks are equipped and mounted at the most outer layer of shaft by washers and screw bolts;
the several fan-shaped eccentric blocks are welded together with a round hole at the center near the shaft; where washer is set between the most inner layer of balance block and eccentric blocks.

11. An eccentric vibrating amplitude device as claimed in claim 10, wherein the depicted eccentric vibrating amplitude device of vibrator comes with a balance block in fan-shape and with arc groove on its surface is its feature.

12. An eccentric vibrating amplitude device as claimed in claim 10, wherein an eccentric vibrating amplitude device of vibrator; where several eccentric blocks come with screw hole at side for fastening by screws and nuts is its feature.

13. An eccentric vibrating amplitude device as claimed in claim 10, wherein an eccentric vibrating amplitude device of vibrator; where the motor shaft drives balance block and several eccentric blocks in rotating; where the screw head of eccentric blocks stretches into arc groove of the balance block to change the angle between balance block and several eccentric blocks is its feature.
